(19) United States
(12) Patent Application Publication
(10) Pub. No.: US 2009/0037217 A1
(43) Pub. Date: Feb. 5, 2009

(54) MULTI-FUNCTIONAL PACKAGE SYSTEM

(75) Inventors: Praful Ramachandra Naik, Pune (IN); Mohan Harakchand Bhandari, Pune (IN)

Correspondence Address: DARBY & DARBY P.C., P.O. BOX 770, Church Street Station, New York, NY, 10008-0770, US

(73) Assignee: BILCARE LIMITED, Pune (IN)

(21) Appl. No.: 12/176,653

(22) Filed: Jul. 21, 2008

(30) Foreign Application Priority Data
Jul. 19, 2007 (IN) 1386/MUM/2007

(51) Int. Cl. G06Q 50/00; B65D 83/04

(52) U.S. Cl. 705/2; 221/5

(57) ABSTRACT

The present invention relates to a multi-functional package system. This integrated package system integrates the aspects authentication, prompting the consumer to consume a product from the package as per a prescribed plan including appropriate patient feedback from clinical trials and/or collection of pharmacovigilance data, real time recording of the history of product dispensed from the package, communicating/interacting with an external device, establishing and converting the package into a non-authentic package after the validity period/expiry period has elapsed or the package has been tampered with or after the entire contents of the package has been dispensed. This multi-functional capability is achieved by the synergistic combination of a tailored coupling/decoupling of the dispensing system, product sensing system, data processing system and communicating/interacting with an external device/system along with the unique identification information provided on the package.

### TECHNICAL FIELD

The invention relates in general to an integrated package system, and more particularly, to authentication of packaged medicinal products and monitoring packaged product usage.

### BACKGROUND ART

Packaging of products influences product shelf-life, usage patterns by consumers, product safety etc. It is desirable to provide products in packages that not only facilitates easy product identification, authentication, dispensation but also has built-in features that help the consumer to achieve higher product compliance. Further it would be useful to capture real time product usage data automatically and integrate the same especially into a healthcare system so that online and off line assistance can be extended to the user as and when necessary. Further the patient compliance and feedback plays a significant role in clinical research/trials as they provide insight by way of pharmacovigilance into the drug/medicine under development.

Several efforts have been made in the past to provide packaging systems for medical dispensation to address the above-mentioned needs.

U.S. Pat. No. 7,072,738 discloses medicament dispenser comprising a refill container which is insertable in said medicament dispenser in order to perform dispensing from said refill container, said dispenser comprising: (a) a memory for storing one or more parameters relating to the functioning of said dispenser; (b) means for storing authentication data for authenticating data for controlling a function of said dispenser; (c) means, in said refill container, for receiving control data for said dispenser; (d) means, in said refill container, for performing authentication of the control data using said stored authentication data; (e) means for, in dependence on a result of the authentication, activating one or more parameters in said memory to control functioning of said dispenser in accordance with said control data characterized in that in use, said refill container stores said control data and following said authentication, and said control data is transferred from said refill container to said dispenser.

United States Patent 20060184271 discloses an automatic prescription pill dispensing unit using a cartridge in which prescription drugs are pre-loaded, preferably by a pharmacist, according to the user's medication regimen. This tamper-proof cartridge can only be unlocked by a pharmacist using a specially designed loading dock, or by inserting the cartridge into the user's dispensing unit.

A unit dose compliance monitoring and reporting device and system is disclosed in U.S. Pat. No. 6,973,371. It includes a dispenser shell formed with dose compartments. A retainer sheet affixed to the shell seals each compartment and partially bursts upon dispensing. A sensor network and monitoring and reporting circuitry records dispensing times and determines an average time interval, which can be reported with other data on an integral data display. The system can thereby monitor and report patient compliance with prescription regimens.

United States Patent 20050030163 discloses a medicine dispenser. It comprises of dispensing device for dispensing medication including a habitually used mechanism for being used habitually by a patient and a medication dispensing mechanism for dispensing medication at the times of the use of the habitually used device.

A smart automatic medication dispenser is disclosed in U.S. Pat. No. 5,752,621. The specific purpose of this computer controlled dispenser device is to provide a convenient vehicle and means by which properly proportioned medication doses are housed and automatically delivered to a patient in single complete doses. Contained within the dispenser device is the ability to dial out and receive telephone messages to inform health care personnel of the dispenser's status, usage and to change internal dispenser programs.

A medication container-holding device indicating usage time is disclosed in U.S. Pat. No. 5,170,380. It comprises of a holding device for medication containers of essentially any size or shape providing the patient information on with the last time the medicine was taken. The device includes a housing with a cylindrical cup shape opening with a micro switch member extending through an access opening into the cavity form one side of the opening. Individual positioning devices in the form of vertical open cylindrical tubes are sized to fit particular containers with the cylinders positioned proximate the switch member with an opening to allow the switch member to extend into the cylindrical bore opening. A bushing and interlocking tab index the position of each cylindrical tube in the correct position each time the positioning device is inserted into the base section of holding device. The sensor signals that a container is placed in the base, which is used to provide through numerical display the time the last medication was taken, the elapsed time since that dose and the number of times the medication was accessed in one day. A settable alarm is provided to alert the patient as to the next time to take the medicine.

U.S. Pat. No. 5,826,217 discloses a Programmable Medicine Dispenser and Storage Device for allowing for user or physician programming of a medication administration schedule, alerting the user, by means of an audible alarm, of a scheduled medication administration time, opening a corresponding medication compartment upon user acknowledgment of the alarm and instructing the user on the proper method of taking the medication. The device includes a real time clock for generating real time signals, a keypad for setting each medication administration time, an acknowledgment key for generating an acknowledgment signal, a programmable controller for activating the alarm in response to the medication administration schedule when each medication administration time is the same as the real time signal and for processing the acknowledgment signal, and at least one medication compartment having a lower compartment and a lid hingedly and latchedly attached thereto, each medication compartment further having an unlatching mechanism for unlatching the lid from the lower compartment when each medication administration time corresponds to the real time signal and in response to the acknowledgment signal, the unlatching mechanism being connected to the programmable controller.

A dispenser is disclosed in the international patent application number WO 2005/004786. The invention comprises of a storing area for storing the unit products, an outlet opening, a dispensing mechanism actuable to dispense unit product through the outlet opening and dispensing indicator integrated with dispenser such that it is automatically updated in response to the dispensing of the unit product.

European Patent EP1495746 discloses a medical dispenser, a blister card for use in the dispenser and a method of dispensing medical doses It is adapted to inform a user of when to take medication, detect when the user accesses the medication and inform the user of his/hers compliance to a medication schedule. The dispenser may inform the user with differing manners of informing (sound, light, vibration, higher of lower frequency or intensity) depending on the user's compliance. Blister cards for use in the dispenser may be coded in order to inform the dispenser of a medication schedule, a desired compliance level, etc. The user may himself code the blister card. The dispenser may hold a blister card or may be adapted for providing medical doses for inhalation or injection.

European Patent EP1006982 discloses a medicament dispense sensing device to register the dispensing of medicaments comprising sensing devices located at the medicament side to detect the dispensing thereof. The device is comprised of a sheet-like envelope of a one-way material and being a continuous, foldable way adapted to enclose the medicaments. There is an electronic printed circuit applied on the envelope and is stretched over foldable areas of the sheet-like envelope. It is also operatively connected to the sensing devices and to an electronic unit

European Patent EP1389083 discloses a medicine dispenser. The invention relates to the art of dispensing medicine to a user of medicine, and relates in particular to a medicine dispenser for dispensing doses of medicaments, a loader for loading doses of medicine into the medicine dispenser, a medicine distribution box, a packing device for packing medicaments in predefined doses, a Central Medication Database and a system comprising all these objects. Furthermore, the invention relates to a method of dispensing doses of medicaments, a method of loading medicine into a medicine dispenser, a method of distributing medicine, a method of packing medicaments in predefined doses, a method of carrying out various aspects related to dispensing medicine as well as a method integrating all the above mentioned methods.

European Patent EP0855894 discloses a method for controlling a drug dispensing system. It is an automated drug dispensing system including, a cabinet adapted to store a variety of prepackaged pharmaceuticals in a plurality of bins for filling patient prescriptions. Each bin stores a particular variety of packaged multiple-dose pharmaceutical. Each variety of pharmaceutical is associated with a particular code. A controller receives request signals and in response generates dispense signals. Each bin includes a dispenser coupled to the controller for dispensing the packaged pharmaceuticals there from in response to a dispense signal sent from the controller. After a package is dispensed, a code reader determines the code of the dispensed package and verifies whether the code on the dispensed package matches the code of the requested package.

European Patent EP0656200 discloses an apparatus for dispensing medication. It comprises a medication dispenser for use in a hospital or other medical setting comprises a plurality of containers for holding medication units, packaging apparatus for containing one or more medication units in a package and robotics for manipulating a selected container to transfer one or more medication units from the container directly to said package. Since medication is directly transferred from the container to the package, no cross-contamination occurs.

### SUMMARY OF THE INVENTION

In one embodiment, the multi-functional package system comprises of a package housing; product containment; a dispensing system; an embedded system comprising data logging and storing means optional data processing means, communication/interaction means, real time clock, induced or built in power source; non-accessible compartment for the said embedded system; a separate non-accessible product containment; a means for authentication in the form of unique identification information; optional display/interactive means; a sensing means comprising signal generating provision that activates/deactivates upon dispensing of the product from the package; means to establish connection of the power source with the said embedded system; wherein the said embedded system is configured with the sensing means and optionally with authentication means and is housed in the said compartment wherein the said compartment is operably connected with the said containment; wherein the said package is authenticated by an external device/system; optionally prompting product consumption; the said sensing means senses the product dispense, the said embedded system records and transmits/communicates data related to product dispense time via said interaction/communication means to an external device/system, rendering the package un-authentic in case of compromise/tampering.

In another embodiment, a reader means is provided to identify and read the unique identification information on the said package wherein the reader means is suitably able to detect the identification information relating to the product package and conveys the information or generates a signal in response to the information which is communicable to the external device. Suitably, the information is encoded and preferably is optical, electronic or magnetic wherein the reader means comprises of one or more reading elements arranged to correspond to the position of each set of identification information on the package for reading the at least two sets of identification information; wherein the said reader means is adapted to read a signal from the at least one identification feature of each of the at least two sets of identification information arranged on or incorporated within different surfaces, sides or planes of the package, and wherein the reading device is configured such that it defines the spatial relationship between a first discrete area of the first set of identification information to be read and a second discrete area of the second set of identification information to be read, and determining, using the reading device, at least one characteristic of a property of the at least one identification feature of the first set of identification features, thereby obtaining a first signal, determining, using the reading device, at least one characteristic of a property of the at least one identification feature of the second set of identification features, thereby obtaining a second signal, using a processing unit to derive/form/generate at least one signature for the object, using said first and said second signals (and thereby inherently or explicitly the features' spatial relationship).

### BRIEF DESCRIPTION OF THE DRAWINGS

The accompanying drawings, which are incorporated in and constitute a part of this specification, illustrate an implementation of apparatus and methods consistent with the present invention and together with the detailed description, serve to explain advantages and principles consistent to the invention. In the drawing,

FIG. 1 is a Schematic of the product package system;

FIG. 2 illustrates the product sensing means;

FIG. 3 illustrates the configuration of a package;

FIG. 4 illustrates the configuration of a second package;

FIG. 5 illustrates the configuration of a third package;

FIG. 6 illustrates the configuration of a fourth package;

### DESCRIPTION OF EMBODIMENTS

The following description is presented to enable any person skilled in the art to make and use a system and method to facilitate authentication and safe usage of packaged medicinal treatments in accordance with embodiments of the invention. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

While prior packages and systems to monitor use of medicinal products generally have been acceptable, there have been shortcomings with their use. For example, there are no packages and/or devices that provide integrated solutions for product authentication, prompting the consumer to consume a product from the package as per a prescribed plan, sensing and quantitatively recording the product removal from the package, real time recording of the history of product dispensed from the package, and communicating the data to an external device which is a growing need. Also, there is no multi-functional package system that intimates the user of a compromise of the package rendering it non-authentic/tampered with.

The present invention aims to meet these needs by addressing the shortcomings of the prior art and provides a novel multi functional package system that can be used effectively for any packaged product, which enables any user to provide himself/herself with all the key features which would enable effective usage of the product along with the effective real-time capture of his/her feedback for own use or optionally for communicating the same for better management by the related service providers.

The invention aims to provide a package with a dispensing system that integrates the aspects of authentication, prompting the consumer to consume a product from the package as per a prescribed plan including appropriate patient feedback from clinical trials and/or collection of pharmacovigilance data, real time recording of the history of product dispensed from the package, communicating/interacting with an external device, establishing and converting the package into a non-authentic package after the validity period/expiry period has elapsed or the package has been tampered with or after the entire contents of the package has been dispensed.

The invention aims to establish the genuineness of a product pack and provide, a package system to authenticate the product and further sense, record and transmit real time product dispensing data from the package to an external device; a package that senses and records real time data of the product dispensed from the package and monitor product usage and to alert the user to take appropriate steps to procure replacement.

The invention also aims to establish and convert the package into a non-authentic package, after the validity period/expiry period has elapsed or after the entire contents of the package has been dispensed; after package has been tampered with or after the entire contents of the package has been dispensed; is not authenticated within a stipulated time after package activation.

The invention also aims to facilitate user compliance including appropriate patient feedback from clinical trials and/or collection of pharmacovigilance data and optionally communicating product dispensation and user/product usage related information including pharmacovigilance related information in clinical trials.

FIG. 1 is a schematic of one of the embodiments depicting various components of the package system wherein the package comprises of non-accessible product containment 1 with a product dispensing provision 5; non-accessible compartment 2 embedded system 3 along with a communication means 4 included in the said package to communicate with an external device 50, a means for authentication such as an encoded chip or a pattern or a random pattern or a marker or combinations thereof (not shown).

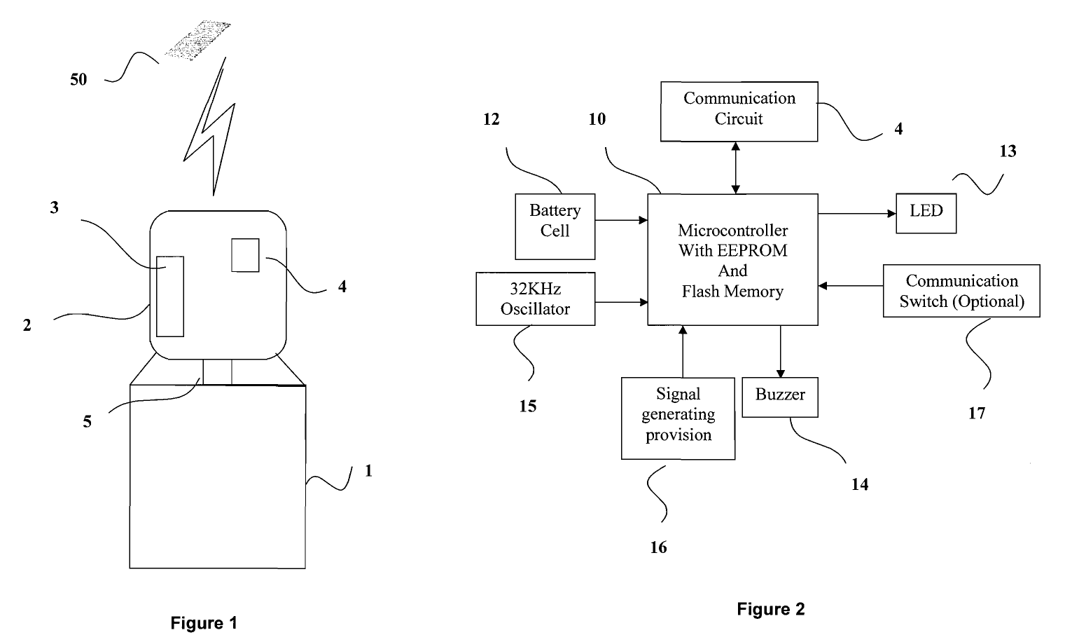

FIG. 2 illustrates the said product embedded system 3 comprising of data processing means 10 with data logging and storing means configured with a communication means 4, an optional communication switch 17, a power source 12, a visual display such as LED 13, audio signal generating means 14, an oscillator (Real time clock) 15. There is provided a product sensing means integrated with signal generating provision/s 16 that gets activated upon dispensing of the product from the package and sends a signal to the said data processing means 10. The activation of the signal generating provision may be done by various means such as electronic, mechanical, optical, visual. In a specific embodiment, the said visual display 13 and the audio signal generating means 14 alerts the user of the time and date of the products to be consumed and also provides quantitative information about the number of products in the package. As the user dispenses the product a signal from the said signal generating provision 16 is sent to the said data processing means 10 wherein the time & date of product dispensed is logged into the data logging provision of the said data processing means 10. Using the optional communication feature, the user may transfer the logged data to an external device by optionally embedded communication switch 17.

In one of the embodiments said logged data in the said data processing 10 is transferred/transmitted via communication means 4 to an external device/s 50 with the aid of RF wherein the said logged data to be transferred is superimposed on the RF field, generated by the RF circuit. In yet another variant of this embodiment the said logged data in the said data processing means 10 is transferred/transmitted via communication means 4 to the said external device/s 50 using an IR link wherein the said logged data to be transferred is in the form of coded pulses or frequency. In yet another variant of this embodiment the said logged data in the said data processing means 10 is transferred/transmitted via communication means 4 to the said companion device through wired and/or any direct contact methods such as I2C, SPI, serial or parallel communication but not limited to these. In yet another variant of this embodiment the data is transferred using wireless communication means such as Bluetooth, Wi-Fi, Zeegbee, Wi-Max, GPRS, GSM, Wibree but not limited to it. Various configurations of the dispensing provision integrated with the sensing system and their functional relation is illustrated hereunder using non-limiting examples.

FIG. 3 illustrates a variant of the package. The sectional view is depicted in FIGS. 3 (a) and 3 (b). The package comprises of non-accessible product containment 20 comprising product dispense region 22, spring 25, embedded system 3 comprising an authentication means used for authentication, signal sensing means comprising signal generating provision 16, a movable element in the form of a reciprocable element 23 wherein the said embedded system is housed in the same. The said product containment 20 is adapted to slide in the package body 26. The said product dispense region 22 reciprocates in the passage 27 formed in the said package body 26. The said reciprocable element 23 is in connection with the said containment 20 so as to transmit reciprocal movement of 23 to 20. When the said element 23 is pressed after unlocking (not shown), it moves downwards as indicated by arrow 100 which results in the downward movement of the said containment 20 (indicated by arrow 100) and in turn of the product dispense region 22 in the said passage 27 resulting in dispense of a product. During the downward movement of 20, the signal generating provision 16 that is in the form of an electromechanical switch is activated and the signal is sent to 3 indicating that the product is dispensed. Further the said sensing system 3 functions as mentioned above. When the said element 23 is released, 20 is regained to original position by virtue of spring 25. It is to be noted that the product sensing system 3 is completely isolated from the product in the said containment 20. The two distinct operations of unlocking and pressing the said element 23 offer child resistant and senior friendly aspect to the package.

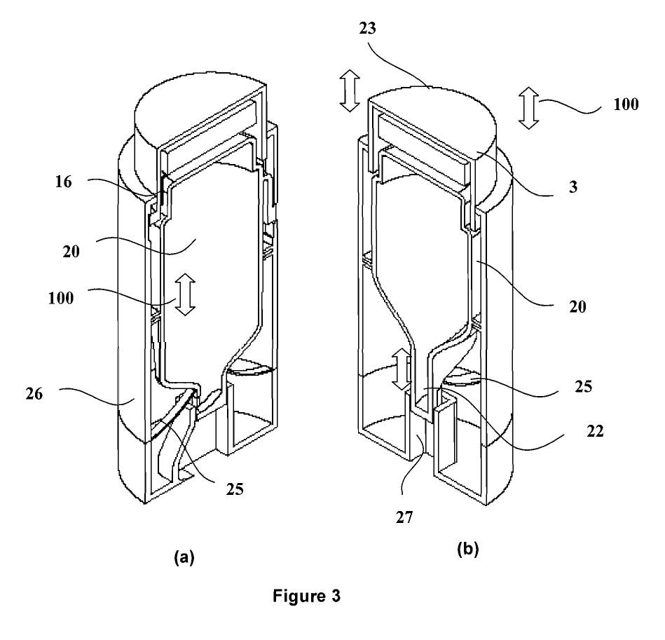

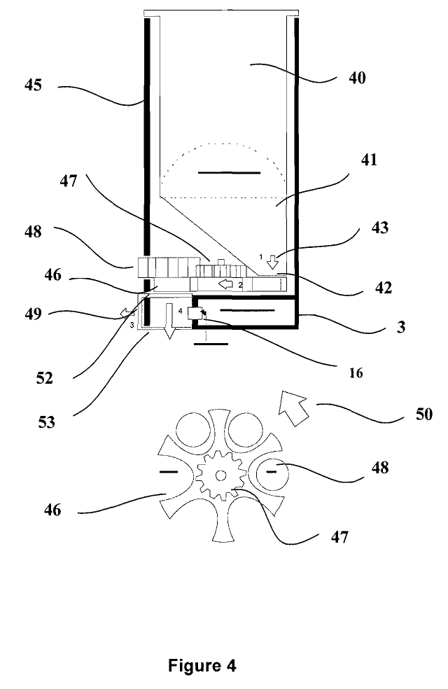

FIG. 4 illustrates yet another variant of the package. Front and top view of the package is depicted in the FIG. 4. The package comprises of containment region 40 comprising a combination of tapered and profiled regions 41 wherein unit product is allowed to pass through the opening 42 in the desired orientation in the direction shown by the arrow 43, the said containment region is adapted to fit in the housing 45. The dispensing system comprises of a product magazine in the form of a rotatable member/wheel with profiled arms 46 in the radial direction shown in the top and front view wherein product (shown as 48) can accommodate between two arms. The said wheel is disposed below the said containment and in particular opening 42 such that unit product from the said opening 42 falls between the arms 46. The said wheel is fitted with a gear 47 that is engaged with another rotatable wheel 48. The wheel 48 is disposed in the said housing 45 such that it is operable by the user. The sensing means 3 is disposed in the housing 45 as shown in the figure. The signal generating provision 16 is disposed in the passage 49 formed in the said housing 45 below the said wheel (having arms 46) such that the opening 52 of the passage coincides with the distance between two consecutive arms 46. In one of the variants the provision 16 is in the form of an optical switch. In yet another variant 16 is proximity switch. In operation, upon rotation of the said wheel 48 by the user, the gear 47 also rotates resulting in the rotation of the arms 46 in the direction indicated by 50. This results in the displacement of the product 48 between the arms in the horizontal direction as indicated by the arrow in the figure. During the rotation, when the said two arms (and the product between the same) coincide with the opening 52, the product falls in the said passage 49 and the product dispense is sensed by the said provision 16. Slider means 53 is provided at the said opening 52 to avoid dispense of two products at a time.

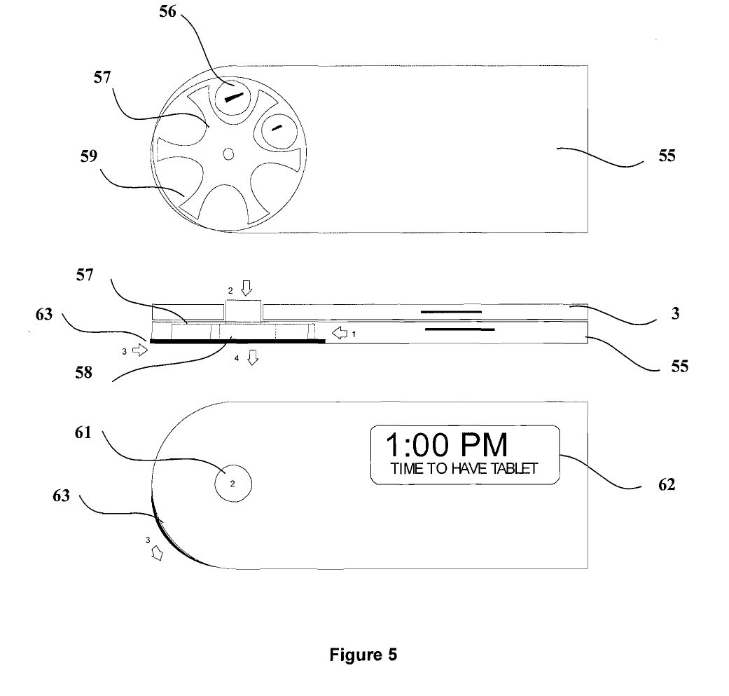

FIG. 5 illustrates yet another variant of the package. It comprises of substantially flat product containment region 55 provided with a opening 58, the dispensing system is in the form of a rotatable member 57 provided with at least two radial profiled arms 59 disposed in the said containment as shown in the figure wherein a product 56 can be accommodated between two consecutive arms 59, the said rotatable member 57 is fitted with a cylinder 61 and a second rotatable wheel 63 that is operable by the user. The said cylinder 61 protrudes out of the body 55. The sensing means 3 is disposed above the said containment region 55. The said sensing means includes the signal generating means (not shown) disposed in the vicinity of the said opening 58. There is provided an optional display means 62 disposed above the sensing means closure. In operation, the user has to press the said cylinder 61 and further rotate the said wheel 63. This results in rotation of the said rotatable member 57 thereby rotating the arms 59 and the product therein. When the said product coincides with the opening 58, it gets dispensed in the passage 58. The dispensing of the product is sensed by the said signal generating means that is in the form of a proximity sensor. The sensing means further operates as described above.

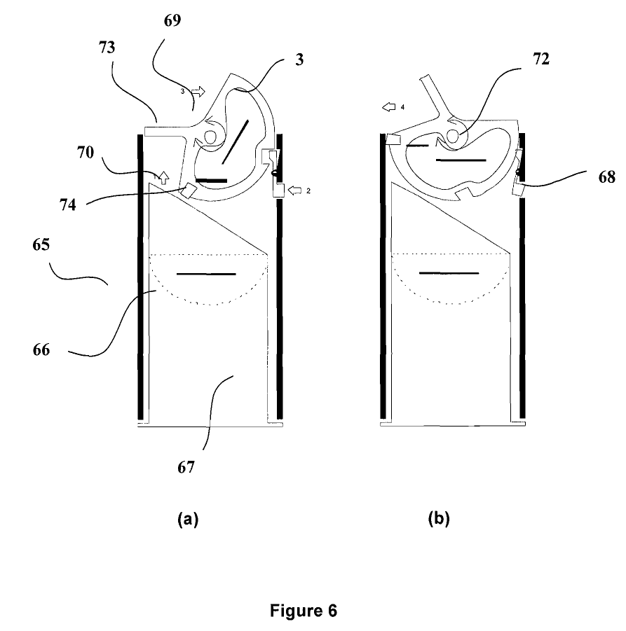

FIG. 6 illustrates yet another variant of the package. The package comprises of a housing 65, containment portion 67, truncated profile region 66 so as to guide a product in the desired orientation to the dispense zone 70, dispensing system in the form of a partially rotatable element 69 that is operable by the user wherein the said element 69 is provided with an arm 73 that closes the said dispense zone 70, spring adapted to fit on the said element 69, locking lever 68 disposed on the housing and operable by the user, sensing means 3 provided with a signal generating provision 74 is adapted to fit on the said element 69 in the vicinity of the said dispense zone 70. During the operation, the user has to tilt the said package and unlock the said locking lever 68 first to partially rotate the said element 69 as shown in FIG. 6 (b). Partial rotation of the element 69 results in displacing the product in the said dispensing zone 70 by one of the faces of the said member 69 to dispense the product. In operation, when the said rotatable element 69 is partially rotated to dispense the product in the zone 70, the said signal sensing generating provision 74 comes in proximity with the wall of the said housing as shown in FIG. 6 (b), senses the dispense of the said product. The sensing means further operates as described above.

In one of the embodiments, the signal generating means is based on mechanical Trigger. In one of the variants of this embodiment the signal generating means is a lever switch. In another variant it is Micro Push Button. In yet another variant, it is cam switch.

In another embodiment, the signal generating means is based on Optical switch. In one of the variants of this embodiment the said signal generating means is Reflective LED Transistor. In another variant it is LDR (Light Dependent Resistor). In yet another variant it is Color. In yet another variant it is Optical Encoder that includes Circular Disc. In yet another variant it is Optical Encoder based on linear detection methods.

In another embodiment, the signal generating means is based on Material Detection of the package.

In yet another embodiment, the signal generating means is a Pressure Sensor.

In another embodiment, the signal generating means is based on Resistance measurement.

In yet another embodiment, the signal generating means is an Accelerometer based on velocity Measurement.

In another embodiment, the said closure swivels around the said product containment.

In yet another embodiment, the closure comprises of a movable element that activates the said product sensing system upon dispensing of the product from the said containment.

In another embodiment, identity of the product package is verified to authenticate the same by providing the package with at least two sets of identification information comprising a first set of identification information and a second set of identification information, wherein at least one identification feature of the first set of identification information is arranged on or incorporated within a different surface, side or plane of the package, with respect to at least one identification feature of the second set of identification information, thereby adapting the package to be identified.

In another variant of this embodiment, the identification tag is affixed/attached to the package wherein the identification tag comprises of at least two sets of identification information comprising a first set of identification information and a second set of identification information, wherein said at least one identification feature of the first set of identification information and said at least one identification feature of the second set of identification information are arranged at a fixed relative spatial position with respect to each other, said fixed relative spatial position being used to derive a signature for identifying the package; wherein the reader means/device comprises of one or more reading elements arranged to correspond to the position of each set of identification information on the package for reading the at least two sets of identification information; wherein the said reader means is adapted to read a signal from the at least one identification feature of each of the at least two sets of identification information arranged on or incorporated within different surfaces, sides or planes of the package, and wherein the reading device is configured such that it defines the spatial relationship between a first discrete area of the first set of identification information to be read and a second discrete area of the second set of identification information to be read, and determining, using the reading device, at least one characteristic of a property of the at least one identification feature of the first set of identification features, thereby obtaining a first signal, determining, using the reading device, at least one characteristic of a property of the at least one identification feature of the second set of identification features, thereby obtaining a second signal, using a processing unit to derive/form/generate at least one signature for the object, using said first and said second signals (and thereby inherently or explicitly the features' spatial relationship). The processing unit may further be adapted to update the pre-stored reference signature by storing data of a read signature as an updated pre-stored reference signature for a future verification check wherein it is not necessary that the pre-stored reference signature be stored permanently in the memory of a reading device; the reading device is adapted to receive the pre-stored reference signature that is stored in a remote data storage medium that can be accessed from a local area network (LAN) or a wide area network (WAN), such as the Internet, for example. Alternatively, the reading device may be able to receive the pre-stored reference signature that is stored in the package to which the tag is attached or the package to be identified. The reading device may thus also be adapted to read a conventional barcode, a two dimensional barcode, a magnetic strip or memory chip.

In another variant of this embodiment, the package or the tag may additionally have stored further information, for example, the price of the package, the manufacturer name thereof or the like. Such information may be included in a conventional bar code, a two-dimensional bar code, a magnetic strip or a memory chip.

In another embodiment, regardless of the type of identification information that is used, both the first and the second sets of identification information are arranged or contained within different sets of surfaces, sides or planes of the package/dispenser or on a tag or both. Several combinations of arrangements are possible.

In another variant of this embodiment, the first set of identification information is arranged on a first surface of the package (such as the top surface) and the second set of identification information is arranged on a second surface of the package (such as the lateral surface or the bottom surface). For example, both the first and the second sets of identification information can be printed directly on a surface of a package, or both maybe printed on adhesive sheets and then affixed to the surface of the package. One implementation of such an arrangement in a tag that is to be used in conjunction with this method is a strip having at each end a set of identification features. Such a strip can be folded to form a loop for attachment to a part of a package.

In yet another embodiment, the identification information may comprise an identification layer in which, at least in part, a plurality of randomly distributed particles is present. The randomly distributed particles may comprise a material that displays one or more consistently measurable physical properties, such as magnetic field strength, capacitance or conductance wherein “randomly distributed particles” includes voids, bubbles, or magnetic domains with a continuous material, or regions of varying reflectivity, or electrical properties. In one of the variants of this embodiment the identification layer comprises a plurality of randomly distributed magnetic or magnetisable particles derived from the elements Fe, Ni, Co, their alloys, oxides, mixtures and combinations thereof.

In yet another variant of this embodiment different types of identification information such as barcodes, magnetic tags, RFID tags, fluorescent particle tags and electrically conductive particle tags is used wherein the relative spatial position between identification features of different combinations of different sets of the said identification information can be used to identify the package, including but not limited to, combinations such as barcode-barcode, barcode-magnetic tag, barcode-fluorescent tag, magnetic tag-magnetic tag, magnetic tag, fluorescent tag, and so on.

In another embodiment, it is possible to include one or more further sets of identification information on the product package. The further set or sets of information may be arranged on any surface, plane or side of the object including the surfaces, sides or planes containing the first two sets of identification information.

In another embodiment, the identification tag comprises at least two sets of identification information comprising a first set of identification information and a second set of identification information. The first set of identification information and the second set of identification information are each arranged within a different surface, side or plane of the tag or package. Identification features of the first set of identification information and identification features of the second set of identification information are arranged at a fixed relative spatial position with respect to each other, said fixed relative spatial position being used to form/derive or generate the signature for the package.

In yet another variant of this embodiment, at least one set of identification information comprises an optically readable pattern. Any optically readable pattern can be used for this purpose, including any variety of printed symbols such as printed dots, a matrix of consecutive numbers, 1-dimensional barcodes, and 2 dimensional barcodes such as Aztec Code, Code 1, Code 49, PDF 417, QR Code, Super Code, and Ultra Code, for example.

In yet another variant of this embodiment, at least one of the first set of identification information and the second set of identification information is derived from at least one identification layer in which readable identification features are located. For this purpose, the identification layer may comprise a layer of any type of suitable material or combination of materials having one or more properties that are quantifiable in terms of a measurable physical quantity.

In yet another embodiment, the identification layer comprises a host material having pores, wherein at least some of the pores contain the particles. As explained below the particles may consist of a magnetic or magnetisable material or of a substantially electrically conducting material. In other embodiments, the particles may be randomly dispersed in a matrix or the particles may be provided by sputtering/ion implantation (cf. also Examples). By providing such a (highly) disordered structure with particles to define the identification features in the identification layer, the information can only be imitated with extremely high effort and/or cost thereby improving the security of the identification system. Any material exhibiting magnetic properties can be used in the identification layer, including but not limited to magnetic materials such as ferromagnetic materials, anti-ferromagnetic materials and ferromagnetic materials. Magnetic materials used include but are not limited to ferromagnetic materials such as Fe, Ni, Co, Gd, Dy, the corresponding alloys, oxides and mixtures thereof, and other compounds such as MnBi, CrTe, EuO, CrO2 and MnAs. Other materials influenced by magnetism are also contemplated. Examples of such materials include ferromagnetic materials e.g. spinels, garnets and ferrites such as magnetite. Other materials commonly used in magnetic media, such as alloys of Ce, Cr, Pt, B, Nd (e.g. Nd—Fe—B, Nd—Fe—Co—B, Nd—Pr—Fe—Co—Ti—Zr—B), Sm (e.g. SmCo5), and alloys such as, AlNiCo, Permalloy and MuMetal are also contemplated.

In yet another variant of this embodiment, in order to support the magnetic particles, a supporting layer maybe arranged below the identification layer. Additionally, the tag or the object may comprise a cover layer, so that the identification layer is arranged between the support and the cover (top) layer. In principle, every material that is compatible with the identification layer can be used as a support and/or cover layer. Examples of suitable materials include, but are not limited to plastics, metals, ceramics, textiles, natural materials such as leather or wood and combinations thereof. Examples of suitable plastics include polymeric materials such as polyethylene, polypropylene, polyester, polyether, polystyrene, polycarbonate, poly(meth)acrylate that are commonly used for the production of plastic articles such as bags, credits cards, packing materials, sheets etc. Suitable ceramics include, but are not limited to, glass, alumina, silica, bone china, enamels, and vitreous frits.

In yet another embodiment, one or both of the sets of identification information is/are covered by a protective coating. In principle, every material that is suitable for physically protecting the identification information from damage (for example, by chemical and/or mechanical degradation) can be used, as long as this material does not prevent at least some of the identification features from being read. Examples of suitable material that can be comprised in the protective coating include, but are not limited to, polymeric coatings such as Teflon coating, a rigid polymer, a sol gel or vapor deposited material such as an oxide, nitride, amorphous diamond, a diamond-like material (film) such as diamond-like carbon, tetrahedral amorphous carbon or a spun-coated lacquer.

In yet another embodiment, to authenticate the package; the reading devices work as follows: when the device is brought up to the object, the barcode reading element senses that it positioned over a white reflective surface (i.e. it is positioned on the object before the start of the barcode). When the user swipes the reader across the package the barcode sensor senses the rapid changes between black and white regions which represent the beginning of the barcode. At this point the reading device's microprocessor (processing unit) is programmed to start acquiring (and storing) data from both the barcode sensor and the magnetic sensor.

In yet another variant of this embodiment, the reading device is adapted to send the read signature to a remote device (such as a computer) that stores the pre-stored reference signature. That remote device compares the signatures and sends back a response identifying the item and providing any additional information that may be required. Often the actual reading device itself communicates with the remote device via a communication device (e.g. a cellular phone, a computer that is connected to the internet, or through a fixed line communication device). In this embodiment the remote device need not send a message back to the reading device itself, but rather the message may be sent back to the communication device which then displays the information to the user. For example, if the reading device communicates via a cellular phone, then the remote device need only send back a message to the cellular phone. The cellular phone may display the information to the user without sending any of the information back to the actual reading device itself.

In yet another variant of this embodiment, the identity of the package is authenticated or verified by matching the signature read from the object against pre-stored reference signatures stored on a database. In addition the verification may include checking individual signals obtained from readings of identification features of either set of identification information (i.e. matching a read magnetic signal against an authenticating magnetic signal) or checking any other information within the identification information (e.g. numerical meaning such as 0, 1, 2, 3, 4, 5 to 9 assigned to various barcode patterns).

In yet another variant of this embodiment, authentication may also be carried out wherein a signature from simultaneous readings of the first and the second set of identification information can be checked directly against the pre-stored reference signature without having to determine the area of overlap between read signature and the pre-stored reference signature. The pre-stored reference signature may be stored in any suitable data storage medium (typically a memory chip or hard disk drive) and most preferably accessed remotely using, any method that is suitable for this purpose, For example, remotely accessing the data storage medium can be carried out using the internet, mobile access such as General Packet Radio Service, GPRS, protocols, a fixed line access, a local area network, a bluetooth protocol, a short messaging service 5 (SMS) or a multimedia messaging service (MMS) signal, to name only a few possibilities.

In yet another embodiment, means for authentication is selected from a semiconductor with read write capability and non-volatile memory, chemical encoding material, magnetic encoding with unique magnetic properties, sensor that reads unique data patterns using wired or wireless means, taggent or chemical encoder.

In yet another embodiment, the package comprises of containment adapted with the dispensing provision, product sensing system and data receiver/transmitter system.

In yet another embodiment a dispense system is used to dispense pills from the blister pack.

In yet another embodiment, an interaction/communication from external device(s) that is capable of decoding the said encoded chip which writes over/erases the encoded data resulting in irreversible non-authentication of the said chip leading to recognition of the package as non-authentic package after the validity period/expiry period has elapsed or after the entire contents of the package has been dispensed.

In yet another variant of this embodiment, an interaction/communication from external device(s) that is capable of decoding the said encoded chip which writes over/erases the encoded data resulting in exclusive registration of the said package with the said external device/system and rendering it incapable of registration with any other external device/system.

In yet another variant of this embodiment, a means by which an external device writes over/erases the encoded data in the chip optionally through the said embedded system resulting in irreversible non-authentication of the said chip leading to recognition of the package as non-authentic package if the time elapsed in the said timer device in the said package is beyond a stipulated time as defined in the external device thereby safeguarding/intimating the user of pilferage of the said package.

In another embodiment, the package is rendered as un-authenticated by measuring time difference between the said connection of the power source with the said embedded system and package authentication is more than a stipulated time as defined in the external device/system.

In yet another embodiment, there is provided an irreversible means to establish connection of the power source with the said embedded system. In one of the variants of this embodiment the irreversible means is a removable non conducting separator between the power source and the embedded system wherein the said separator gets removed at the time of first dispense of the product.

In yet another variant of this embodiment, the power source is housed in an irreversible snap fit arrangement which on the first act of dispensation gets irreversibly locked to bring power source in contact with the embedded system.

In yet another embodiment the said package is provided with a means configured with the said data processing means 10 to measure physical property/properties of the said package and estimate relative difference between the same to estimate product replenishment time/status of the said package.

In one of the variants of this embodiment, the said physical property is weight of the said package.

It is evident that the present invention provides a multifunctional package system that not only overcomes all the problems in related prior art but also provides an comprehensive package system that integrates the aspects of, authentication; prompting the consumer to consume a product from the package as per a prescribed plan; real time recording of the history of product dispensed from the package; communicating/interacting with an external device/s; establishing and converting the package into a non-authentic package after the validity period/expiry period has elapsed or the package h as been tampered with or after the entire contents of the package has been dispensed.

The above technical effects are achieved by tailored coupling/decoupling of the dispensing system, product sensing system, data processing system and communicating/interacting with an external device/system.

The foregoing description and drawings of preferred embodiments in accordance with the present invention are merely illustrative of the principles of the invention. Various modifications can be made to the embodiments by those skilled in the art without departing from the spirit and scope of the invention, which is defined in the appended claims.

We claim:

1. A multi-functional package system comprising
package housing;
product containment;
a dispensing system;
an embedded system comprising data logging and storing means optional data processing means, communication/interaction means, real time clock, induced or built in power source;
non-accessible compartment for the said embedded system;
a separate non-accessible product containment;
a means for authentication;
optional display/interactive means;
a sensing means comprising signal generating provision that activates/deactivates upon dispensing of the product from the package;
means to establish connection of the power source with the said embedded system;
wherein
the said embedded system is configured with the sensing means and optionally with authentication means and is housed in the said compartment wherein the said compartment is operably connected with the said containment;
wherein
the said package is authenticated by an external device/system;
optionally prompting product consumption;
the said sensing means senses the product dispense, the said embedded system records and transmits/communicates data related to product dispense time via said interaction/communication means to an external device/system, rendering the package un-authentic in case of compromise/tampering.

2. A multi-functional package system as claimed in claim 1 comprising
package housing;
a power source built-in or optionally induced;
a means for authentication such as an encoded chip or a pattern or a random pattern or a marker or combinations thereof;
non-accessible product containment comprising product dispense region adapted to slide in the said package body and reciprocate in the passage formed in the said package body, spring disposed between the said containment and the package body;
an embedded system comprising data logging and storing means optional a data processing means, communication/interaction means, real time clock; an authentication means; signal sensing means comprising signal generating provision mounted on the said containment; wherein the said embedded system is housed in a reciprocable element that is operably in connection with the said containment such that linear displacement/reciprocal movement provided to the said element is transmitted to the said containment thereby activating the signal generating provision;
wherein
upon pressing of the said reciprocal element, the reciprocal movement of the same is transmitted to the said containment and in turn to the said product dispense region that reciprocates in the said passage resulting in dispense of the product wherein simultaneously reciprocal movement of the said container causes activation of the signal generating provision that sends signal indicating dispense of the product to the said embedded system;
wherein
upon release of the said reciprocal element the said containment regains to original position by virtue of spring.

3. A multi-functional package system as claimed in claim 1 comprising
a housing; a power source built-in or optionally induced
an embedded system comprising data logging and storing means optional a data processing means, communication/interaction means, real time clock;
a means for authentication such as an encoded chip or a pattern or a random pattern or a marker or combinations thereof;
containment comprising
an opening, combination of tapered and profiled regions wherein unit product is allowed to pass through the opening in the desired orientation and direction wherein the said containment region is adapted to fit in the housing;
the dispensing system adapted to fit in the said housing in the proximity of the said containment wherein the dispensing system comprises of a product magazine in the form of a first rotatable member with profiled arms in the radial direction wherein unit product can accommodate between the two adjacent arms, gear, sensing means comprising signal generating means configured with the said embedded system, rotatable wheel operable by user wherein the said rotatable wheel is operably engaged with the gear and in turn with the rotatable member such that rotation of the said wheel causes rotation of the said member
wherein the said rotatable member is disposed in the proximity of the opening of the containment such that unit product from the said opening falls between the adjacent arms and is further dispensed in the passage formed in the said housing that corresponds to the distance between two adjacent arms of the member
wherein the signal generating means is disposed in the said passage to sense and transmit information about the dispense of the unit product to the said embedded system;
wherein upon rotation of the said rotatable wheel by the user, the gear rotates resulting in the rotation of the rotatable member resulting in the displacement of the product between the two adjacent arms wherein during the rotation, when the said two arms coincide with the said passage, the product dispenses and is sensed by the said signal generating provision.

4. A multi-functional package system as claimed in claim 1, 3 wherein the said signal generating means is selected from optical switch, proximity switch.

5. A multi-functional package system as claimed in claim 1 comprising
package housing, optional display means; a power source built-in or optionally induced;
an embedded system comprising data logging and storing means optional a data processing means, communication/interaction means, real time clock adapted to fit in the said package housing;
a means for authentication such as an encoded chip or a pattern or a random pattern or a marker or combinations thereof;
substantially flat containment provided with a opening wherein height of the containment is substantially lower than that of length and width;
dispensing system adapted to fit in the vicinity of the said opening of the container wherein the dispensing system comprises of rotatable member with at least two radial profiled arms adapted to accommodated unit product between them, a reciprocable member protruding out of the package housing operably connected to the said rotatable member and disposed above the said rotatable member, a rotatable wheel that is operable by the user engaged with the said rotatable member such that rotation of the said wheel causes rotation of the said member
sensing means comprising signal generating provision in the form of proximity sensor configured with the said embedded system wherein the said signal generating means is disposed in the vicinity of the said opening of the container in the said housing
wherein
pressing the said reciprocable member and further rotating the said rotatable wheel by the user causes rotation of the said rotatable member thereby rotating the said profiled arms and the product therein wherein
resulting in dispense of the product upon coinciding with the said opening of the container
wherein
the dispense of the product is sensed by the said signal generating provision and the product dispense information is transmitted to the said embedded system.

6. A multi-functional package system as claimed in claim 1 comprising
package housing; a power source built-in or optionally induced;
an embedded system comprising data logging and storing means optional a data processing means, communication/interaction means, real time clock adapted to fit in the said package housing;
a means for authentication such as an encoded chip or a pattern or a random pattern or a marker or combinations thereof;
containment provided with truncated profile region so as to guide a product in the desired orientation to the opening;
dispensing system comprising partially rotatable element that is operable by the user wherein the said element is provided with an arm that closes the said opening of the said container, spring adapted to fit on the said element, locking lever disposed on the housing and operable by the user,
sensing means comprising signal generating provision in the form of proximity sensor configured with the said embedded system adapted to fit on the said element in the vicinity of the said opening
wherein
in operation the user tilts the said package and unlocks the said locking lever by pressing the same to partially rotate the said element resulting in displacement of the product from the said opening of the container by one of the faces of the said member to dispense the product wherein the signal sensing generating provision provided on the said element senses the dispense of the product and the product dispense information is transmitted to the said embedded system.

7. A multi-functional package system as claimed in claims 1-6 wherein the activation of the signal generating provision is done using means such as electronic, mechanical, optical, visual.

8. A multi-functional package system as claimed in claims 1-6 wherein information in the said embedded system is transferred/transmitted via communication means to an external device/s using wired and/or any direct contact methods such as I2C, SPI, serial or parallel communication.

9. A multi-functional package system as claimed in claims 1-6, 8 wherein the information is transferred using wireless communication means such as Bluetooth, Wi-Fi, Zeegbee, Wi-Max, GPRS, GSM.

10. A multi-functional package system as claimed in claims 1-6, 7 wherein one the signal generating provision is based on mechanical trigger such as lever switch, cam switch, micro push button.

11. A multi-functional package system as claimed in claims 1-6, 7 wherein; the signal generating provision is selected from optical switch, reflective LED Transistor, Light Dependent Resistor, Color sensing, Optical Encoder that includes Circular Disc, Optical Encoder based on linear detection methods.

12. A multi-functional package system as claimed in claim 1-6, 7 wherein; the signal generating provision is based on material detection of the package.

13. A multi-functional package system as claimed in claims 1-6, 7 wherein the signal generating provision is a pressure sensor.

14. A multi-functional package system as claimed in claims 1-6, 7 wherein signal generating provision is based on resistance measurement.

15. A multi-functional package system as claimed in claims 1-6, 7 wherein the signal generating provision is an accelerometer based on velocity measurement.

16. A multi-functional package system as claimed in claims 1-6 wherein means for authentication is selected from a semiconductor with read write capability and non-volatile memory, chemical encoding material, magnetic encoding with unique magnetic properties, sensor that reads unique data patterns using wired or wireless means, taggent or chemical encoder.

17. A multi-functional package system as claimed in claims 1-6, 16 wherein the package interacts/communication with the external device(s) that is capable of decoding the said encoded chip which writes over/erases the encoded data resulting in irreversible non-authentication of the said chip leading to recognition of the package as non-authentic package after the validity period/expiry period has elapsed or after the entire contents of the package has been dispensed.

18. A multi-functional package system as claimed in claims 1-6, 16 wherein the package interacts/communicates with the external device(s) that is capable of decoding the said encoded chip which writes over/erases the encoded data resulting in exclusive registration of the said package with the said external device/system and rendering it incapable of registration with any other external device/system.

19. A multi-functional package system as claimed in claims 1-6, 16 wherein an external device writes over/erases the encoded data in the chip optionally through the said embedded system resulting in irreversible non-authentication of the said chip leading to recognition of the package as non-authentic package if the time elapsed in the said timer device in the said package is beyond a stipulated time as defined in the external device thereby safeguarding/intimating the user of pilferage of the said package.

20. A multi-functional package system as claimed in claims 1-6 wherein the package is rendered as un-authenticated by measuring time difference between the said connection of the power source with the said embedded system and package authentication wherein the said time difference is more than a stipulated time as defined in the external device/system.

21. A multi-functional package system as claimed in claims 1-6 wherein a removable non conducting separator is provided between the power source and the embedded system wherein the said separator gets removed at the time of first dispense of the product.

22. A multi-functional package system as claimed in claims 1-6 wherein the power source is housed in an irreversible snap fit arrangement which on the first act of dispensation gets irreversibly locked to bring power source in contact with the embedded system.

23. A multi-functional package system as claimed in claim 1-6 wherein the said means for authentication comprises of identification information and a reader device.

24. A multi-functional package system as claimed in claims 1-6, 23 wherein the said identification information comprises of at least two sets of identification information comprising a first set of identification information and a second set of identification information, wherein at least one identification feature of the first set of identification information is arranged on or incorporated within a different surface, side or plane of the package, with respect to at least one identification feature of the second set of identification information, thereby adapting the package to be identified alternately the package is provided/affixed/attached with the identification tag that comprises at least two sets of identification information comprising a first set of identification information and a second set of identification information, wherein said at least one identification feature of the first set of identification information and said at least one identification feature of the second set of identification information are arranged at a fixed relative spatial position with respect to each other, said fixed relative spatial position being used to derive a signature for identifying the package.

25. A multi-functional package system as claimed in claims 1-6, 23, 24 wherein the identification information comprises of an identification layer in which, at least in part, a plurality of randomly distributed particles is present, wherein the randomly distributed particles comprise a material that displays one or more consistently measurable physical properties, such as magnetic field strength, capacitance or conductance wherein randomly distributed particles includes voids, bubbles, or magnetic domains with a continuous material, or regions of varying reflectivity, or electrical properties.

26. A multi-functional package system as claimed in claims 1-6, 23-25 wherein the said identification information comprises of an identification tag that comprises at least two sets of identification information, said at least two sets of identification information comprising a first set of identification information and a second set of identification information each arranged within a different surface, side or plane of the identification tag, and identification features of said first set of identification information and identification features of said second set of identification information are arranged at a fixed relative spatial position with respect to each other, said fixed spatial relationship being used for identifying the package.

27. A multi-functional package system as claimed in claims 1-6, 23-26 wherein the said identification information comprises of identifiers present in the said tag on the product package wherein one identifier comprises a readable layer of randomly distributed material which is capable of encoding identification information, such as conductive material, magnetized or magnetisable material, semi-conductive particle and optically active particles; the second identifier suitably comprises optical information, for example a 1-D or 2-D bar code.

28. A multi-functional package system as claimed in claims 1-6, 23-27 wherein the identification information is encoded and preferably is optical, electronic, magnetic or a combination thereof.

29. A multi-functional package system as claimed in claims 1-6, 23-28 wherein nano/micro particulate materials and/or material composites with measurable material metrics are used on the package as identification information.

30. A multi-functional package system as claimed in claims 1-6, 23-29 wherein a reader device comprising reader means is provided to identify and read the said identification information on the said package.

31. A multi-functional package system as claimed in claims 1-6, 23-30 wherein the reader device comprises of one or more reading elements arranged to correspond to the position of each set of identification information on the package for reading the at least two sets of identification information, wherein the said reader device is adapted to read a signal from the at least one identification feature of each of the at least two sets of identification information arranged on or incorporated within different surfaces, sides or planes of the package, and wherein the reading device is configured such that it defines the spatial relationship between a first discrete area of the first set of identification information to be read and a second discrete area of the second set of identification information to be read, and determining, using the reading device, at least one characteristic of a property of the at least one identification feature of the first set of identification features, thereby obtaining a first signal, determining, using the reading device, at least one characteristic of a property of the at least one identification feature of the second set of identification features, thereby obtaining a second signal, using a processing unit to derive/form/generate at least one signature for the object, using said first and said second signals.

32. A multi-functional package system as claimed in claim 30 wherein reader device comprises of a processing unit adapted to update the pre-stored reference signature by storing data of a read signature as an updated pre-stored reference signature for a future verification check, wherein the reading device is adapted to receive the pre-stored reference signature that is stored in a remote data storage medium that can be accessed from a local area network (LAN) or a wide area network (WAN), such as the Internet, for example.

33. A multi-functional package system as claimed in claims 30, 31 wherein the reading device is adapted to receive the pre-stored reference signature that is stored in the package to which the tag is attached or the package to be identified, wherein the said reading device is adapted to read a conventional barcode, a two dimensional barcode, a magnetic strip or memory chip.

34. A multi-functional package system as claimed in claims 1-32 wherein package authentication is carried out in steps of: bringing the said reading device up to the package; sensing the said identification information on the package by the reading element of the said reading device; acquiring and processing data from the said identification information by the said processing unit of the reading device; comparing pre-stored said reference signature/information in the said processing unit with the said sensed information on the said package for verification check.

35. A multi-functional package system as claimed in claims 1-32 wherein package authentication is carried out in steps of: sending the read information from the package to a remote device such as computer that stores the pre-stored reference information; comparing the said information's by the said remote device; sending back a response identifying the item and providing any additional information that may be required; optionally communicating by the said reading device to the said with the remote device via a communication device such as a cellular phone, a computer that is connected to the internet, or through a fixed line communication device.

36. A multi-functional package system as claimed in claims 1-34 wherein package authentication process includes establishing connection of the said power source with the said embedded system using a removable non conducting separator between the power source and the embedded system wherein the said separator gets removed at the time of first dispensing of the product.

37. A multi-functional package system as claimed in claims 1-35 wherein package is rendered as un-authenticated by measuring time difference between the said connection of the power source with the said embedded system and package authentication is more than a stipulated time as defined in the external device/system.

38. A multi-functional package system as claimed in claims 1-36 wherein the package is provided with a means configured with the said data processing means to measure physical property/properties of the said package and estimate relative difference between the same to estimate product replenishment time/status of the said package.
